(19) United States
(12) Patent Application Publication
(10) Pub. No.: US 2019/0383413 A1
(43) Pub. Date: Dec. 19, 2019

(54) Valve

(71) Applicant: CPT GROUP GmbH, Hannover (DE)

(72) Inventor: Rosario BONANNO, Bad Soden (DE)

(21) Appl. No.: 16/472,112

(22) PCT Filed: Dec. 14, 2017
(86) PCT No.: PCT/EP2017/082879

§ 371 Date: Jun. 20, 2019

(30) Foreign Application Priority Data
Dec. 22, 2016 (DE) 10 2016 226 086.3

(51) Int. Cl. F16K 27/02; F16K 31/06; F02B 37/16

(52) U.S. Cl. CPC F16K 27/029; F02B 37/16; F16K 31/0655

(57) ABSTRACT

A valve having a housing, a solenoid arranged in the housing, a pin movable by the solenoid, a piston connected to the pin, a second housing part composed of metal is provided that bears against the housing and which partially accommodates the piston.

### CROSS REFERENCE TO RELATED APPLICATIONS

This is a U.S. national stage of application No. PCT/EP2017/082879, filed on Dec. 14, 2017. Priority is claimed on German Application No. DE102016226086.3, filed Dec. 22, 2016, the content of which is incorporated herein by reference.

### BACKGROUND OF THE INVENTION

### 1. Field of the Invention

The invention relates to a valve having a housing, a solenoid arranged in the housing, a pin movable by the solenoid, a piston connected to the pin, a second housing part that bears against the housing and which partially receives the piston.

### 2. Description of the Prior Art

Such valves are used, inter alia, as a diverter valve on a turbocharger in a motor vehicles to open up a bypass to the suction side in overrun operation, and are thus known. To prevent excessive deceleration of the turbocharger and ensure a fast launch, fast opening and closing of the valve is an essential prerequisite. The valve seat is formed by the housing of the turbocharger, on which the valve is flange-mounted. In addition, the axially displaceable piston must be sealed against the housing. For this purpose, it is known to arrange a seal in the second housing part, which seal bears in each case against the second housing part and against the lateral surface of the piston. The second housing part, which is composed of plastic, is connected by a detent connection to the first housing part. The second housing part, which for weight reasons is composed of plastic, must, for sufficient strength and for production reasons, have a certain structure and wall thickness. This has the result that a corresponding structural space must be provided. Such valves are therefore adaptable to different installation spaces only to a limited extent.

### SUMMARY OF THE INVENTION

One aspect of the invention is creating a valve which, by its construction, allows use in different installation locations.

The object is achieved in that the second housing part is composed of metal.

The formation of the second housing part from metal has the advantage that it can, in relation to a plastics part, be formed with a considerably reduced wall thickness owing to the higher strength of metal. The smaller wall thickness permits a smaller diameter of the second housing part for an unchanged piston diameter. The valve can thus be installed into smaller openings. Likewise, the seal can be made smaller in diameter, resulting in improved sealing. With the formation of the second housing part from metal, higher temperature resistance is also achieved, which likewise allows use under usage conditions that were hitherto not possible. Furthermore, a metallic second housing part permits a connection to the housing by means of a detent connection or other connections.

In an advantageous refinement, good resistance to a wide variety of through flowing media and media mixtures, preferably exhaust gas of an internal combustion engine, is achieved in that the metal is a high-grade steel, preferably a chromium-nickel steel.

According to a further advantageous refinement, the second housing part can be produced particularly inexpensively as a deep-drawn part. The shaping of the housing part can be achieved in only one working step without further processing operations.

It has been found that, for the use of the valve in a motor vehicle, a wall thickness of 0.3 mm to 3 mm, preferably of 0.5 mm to 1 mm, of the second housing part is sufficient to ensure sufficient strength and thus reliable operation of the valve.

In a particularly advantageous refinement, the second housing part has, at its side facing toward the housing, a radially outwardly projecting edge. The edge can be used as required to create a defined abutment surface for the setting-down on the housing. The edge can be generated in a particularly simple and thus inexpensive manner during the formation of the second housing part by deep drawing.

In another advantageous refinement, the radially outwardly projecting edge can be used to connect the second housing part to the housing.

For this purpose, the edge may on the one hand be set down onto the housing. By a further component to be connected to the housing, the edge and thus the second housing part can be clamped between the housing and the further component and thus fixed in its position.

On the other hand, the radially outwardly projecting edge can be clipped into correspondingly formed detent hooks on the housing in order to achieve a reliable seat on the housing by such a detent connection.

In one advantageous refinement, the second housing part is pressed together with the housing. The advantage consists in that no additional fastening elements are required. Furthermore, owing to the omission of detent elements, the housing can be of significantly simpler design, which results in a considerable cost reduction in the production process.

In a particularly advantageous refinement, the second housing part is pressed together with a return element cast into the housing of the solenoid. The advantage of this refinement consists in that return elements are composed of metal and thus exhibit much higher process stability during the pressing-together than in the case of the second housing part being pressed together with a plastics part. Furthermore, the return element is a component already present in the valve, whereby no additional component is required for the pressing-together with the second housing part.

For particularly simple installation and high reliability of the press-fit connection, it has proven to be advantageous if the return element has a cylindrical portion directed toward the piston and onto which the second housing part is pressed.

For a pressing-on action, which is particularly reliable in terms of a process, it has proved to be advantageous if the return element has an insertion bevel for the second housing part.

In a method to be carried out with one aspect of the invention, the radially outwardly projecting edge of the second housing part may furthermore be used as an engagement point for a pressing tool.

Furthermore, this edge can serve as an abutment on the housing for the pressing-together process to ensure a proper execution of the press-fit connection. This means that a reliable connection of the second housing part to the housing is achieved when the second housing part is pressed on to such an extent that the edge rests against the housing.

For sealing of the piston with respect to the housing, which is reliable in terms of a process, it has proven to be advantageous if the second housing part has, at its side averted from the housing, a radially inwardly directed collar. The advantage consists in that the collar can be used as a receptacle of a seal.

To ensure permanent fixing of the seal on the second housing part, a further refinement consists in clamping the seal on the collar. What is particularly advantageous here is the use of the return element of the solenoid, since in this way no additional component is required. A further advantage consists in that the fixing of the seal can be performed in one working step with the pressing-on. Possible process-induced tolerances during the pressing-on do not influence the clamping of the seal, because such tolerances are compensated owing to the elasticity of the seal.

It is conducive to a further simplification of the valve according to one aspect of the invention if the seal arranged in the housing is connected to the second housing part in order to seal off the valve with respect to the line. This refinement allows the seal to be pre-installed with the second housing part, which facilitates the final installation of the valve. In a particularly simple and inexpensive manner, the seal has, situated radially at the inside, a slot into which the radially outwardly directed edge of the second housing part engages.

### BRIEF DESCRIPTION OF THE DRAWINGS

The invention will be described in more detail on the basis of an exemplary embodiment. In the figures:

FIG. 1 is a sectional illustration of a valve according to the prior art; and

FIG. 2 is a sectional illustration of a valve according to one aspect of the invention.

### DETAILED DESCRIPTION OF THE PRESENTLY PREFERRED EMBODIMENTS

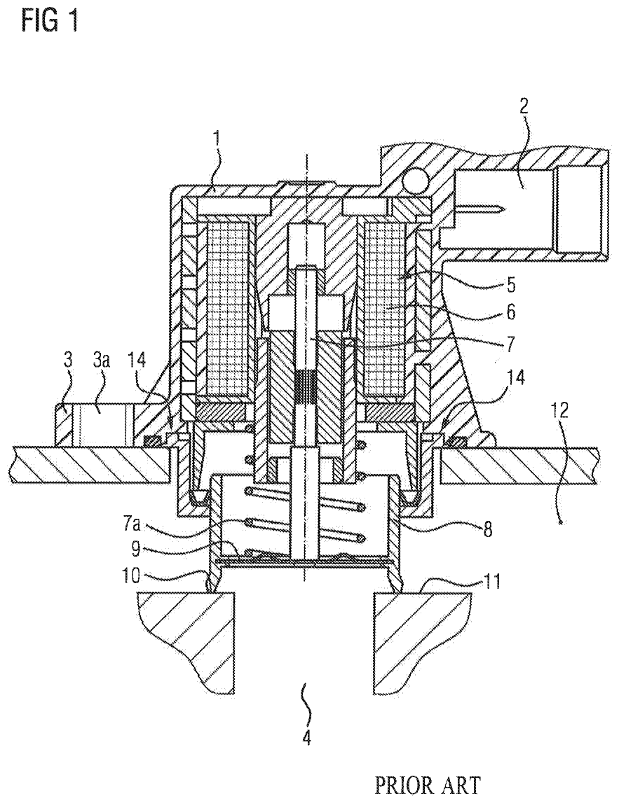

FIG. 1 shows the valve comprising a housing 1 with an integrally molded socket 2 for the electrical connection of the valve. The housing 1 furthermore has an integrally formed flange 3 and three bores 3a, by which the housing 1 is flange-mounted on a turbocharger (not illustrated) in a region of a bypass line 4. In the installed position shown, the flange 3 is adjoined by a second housing part 13 composed of plastic. The second housing part 13 is connected to the housing 1 by a detent connection 14. In the housing 1, there is arranged a solenoid 5, a coil 6, and a metal pin 7. The metal pin 7 is connected to a pot-shaped piston 8, which, at the circumference of its base 9, has an axially projecting annular sealing surface 10. In the closed position shown, the sealing surface 10 bears against the valve seat 11 to close off the bypass line 4 so that no medium can flow from the line 4 into the line 12. Here, a spring 7 pushes the piston 8 in the direction of the valve seat 11.

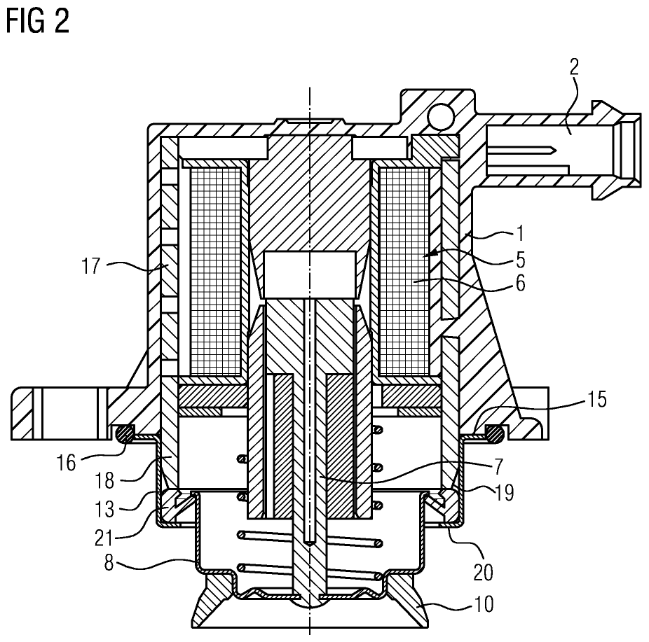

The valve in FIG. 2 has substantially the same design as the valve in FIG. 1. The second housing part 13 composed of a chromium-nickel steel has a wall thickness of 0.5 mm, and is a deep-drawn part. At its end facing toward the housing 1, the second housing part 13 has a radially outwardly pointing edge 15. An O-ring which acts as a seal 16 is arranged in the housing 1 concentrically with respect to the edge 15 in the housing 1. The solenoid 7 has a return element 17, which is encapsulated by the plastic of the housing 1. In its axial extent, the return element 17 has a cylindrical portion 18 which is oriented in the direction of the piston and which, at its end, has a chamfer 19, which acts as an insertion bevel. The second housing part 13 is pressed onto the cylindrical portion 18 to such an extent that the edge 16 bears against the housing 1. The second housing part 13 has, at its end averted from the housing 1, a radially inwardly directed collar 20, on which a seal 21 lies for the purposes of sealing against the piston 8. The axial extent of the second housing part 13 is selected here such that the seal 21 is clamped between collar 2 and portion 18 and is thus fixed in its position.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A valve comprising:
a housing;
a solenoid arranged in the housing;
a pin movable by the solenoid;
a piston connected to the pin; and
a second housing part composed of metal which bears against the housing and partially accommodates the piston.

11. The valve as claimed in claim 10, wherein the second housing part is composed of at least one of high-grade steel and a chromium-nickel steel.

12. The valve as claimed in claim 10, wherein the second housing part is a deep-drawn part.

13. The valve as claimed in claim 10, wherein the second housing part has a wall thickness of at least one of 0.3 mm to 3 mm and 0.5 mm to 1 mm.

14. The valve as claimed in claim 10, wherein the second housing part has, at its side facing toward the housing, a radially outwardly projecting edge.
